(19) United States
(12) Patent Application Publication
(10) Pub. No.: US 2026/0094733 A2
(43) Pub. Date: Apr. 2, 2026

(54) SHIELDING MODULE FOR A RADIOACTIVE WASTE CONTAINER

(71) Applicant: INGECID, S.L., SANTANDER (CANTABRIA) (ES)

(72) Inventors: Jokin RICO ARENAL, SANTANDER (CANTABRIA) (ES); Diego RODRÍGUEZ SAEZ, SANTANDER (CANTABRIA) (ES); Julio Cesar GONZÁLEZ GALVÁN, SANTANDER (CANTABRIA) (ES); David HELGUERA LÓPEZ, SANTANDER (CANTABRIA) (ES); Javier ALONSO SANZ, SANTANDER (CANTABRIA) (ES)

(21) Appl. No.: 18/714,578

(22) PCT Filed: Nov. 29, 2022
(86) PCT No.: PCT/IB2022/000811

§ 371 Date: Dec. 4, 2024

(30) Foreign Application Priority Data
Nov. 30, 2021 (ES) P202131114

(51) Int. Cl. G21F 5/008; G21F 5/08; G21F 5/10; G21F 5/12

(52) U.S. Cl. CPC G21F 5/008; G21F 5/08; G21F 5/10; G21F 5/12

(57) ABSTRACT

A shielding module for a radioactive waste container (C) comprising a perimeter wall (1) and a closing lid (2), which define a cavity (3) suitable for housing the container (C), and a number of metal elements (4) attached along the perimeter wall (1) and protruding into said cavity (3), said metal elements (4) forming means for limiting lateral movement, for centring and for dampening impacts against the side wall of the container (C) with respect to the shielding module (10), in the event of potential external impacts or the sideways fall of the assembly formed by the container (C) and the shielding module (10).

### TECHNICAL FIELD

The present invention is applicable to storage facilities for spent fuel from nuclear power plants and, generally, for radioactive waste.

### BACKGROUND ART

Nuclear power plants generate waste whose storage must be carried out in a controlled manner because of the radioactive chemical elements they contain. One of the storage methodologies consists of placing the waste in special containers whose function is to minimise the radiation emitted by the waste. These containers are provisionally stored in individualised temporary facilities built at the nuclear power plants.

Containers for the storage of nuclear waste generally comprise a hollow body which forms the lateral surface of the container and which is externally provided with trunnions for being gripped and handled, as well as a lid and a closing base fixed, respectively, to the upper and lower ends of the container body.

The walls of said containers are made up of one or more layers of various materials, and are specifically designed not only to act as a shield against the radiation emitted by the waste, but also to withstand any type of event during storage or transport, such as accidental impacts during handling and transport, or earthquakes during their storage in individualised temporary storage facilities.

An additional problem with nuclear waste storage is that it still has the capacity to generate heat, known as residual power, causing the container to heat up and making it necessary to adapt the container design to facilitate effective heat dissipation.

These containers are currently being used to store all the spent fuel temporarily located in the pools of the nuclear reactors and, thus, either to be used at the beginning of the dismantling of the nuclear power plant or to extend its useful life by freeing up space in the pools. This fact causes large quantities of containers to be placed in individualised temporary storage facilities, thus making it necessary to increase the protective capacity of the containers against the radiation emitted by the waste.

### SUMMARY OF THE INVENTION

The shielding module for a radioactive waste container, object of the invention, has suitable technical characteristics to house said container inside and solve the aforementioned problems, both with regard to the protection of the container and the evacuation of the heat generated by the waste housed inside said container.

To this end, and according to the invention, said shielding module comprises a perimeter wall and a closing lid that define a cavity suitable for the placement of a container with the waste to be shielded, and metal elements attached to the perimeter wall of the module and protruding towards the inside of said cavity of the shielding module.

Said metal elements form a means for limiting lateral movement, for centring and for dampening the container with respect to the shielding module in the event of potential external impacts, or the sideways fall of the assembly formed by the container and the shielding module. The metal elements have a certain elasticity that makes it possible to absorb the impacts received in the wall of the shielding module, minimising the transmission of these forces to the container through the structural deformation of these metal elements.

The shielding module laterally comprises upper and lower windows for the evacuation of the heat released by the container and generated by the stored waste by natural convection, between the inside and outside of the module.

The lower windows are defined in the perimeter wall and form inlets for air at room temperature, and the upper windows are defined in the perimeter wall, or between the upper end of said perimeter wall and the lid of the shielding module, and form outlets for the air that enters through the lower windows and is heated as it rises through the space between the container and the perimeter wall of the shielding module.

The metal elements located along the inner wall of the shielding module, and responsible for minimising the transmission of potential external impacts of the shielding module to the container housed therein, preferably have a configuration in the form of sheets that are oriented in an upward direction and define heat circulation passages, by convection, between the lower windows and the upper windows of the shielding module. However, it is not excluded that said metal elements may have other different configurations, suitable for cushioning potential external impacts and avoiding damage to the container.

According to the invention, the perimeter wall of the shielding module can be a single-piece or may consist of at least two wall sections coupled to each other, for example: vertically superimposed, provided with a tongue and groove fitting, or fixed to each other by screws or other suitable fixing elements.

Preferably, and in order to provide protection against the radiation emitted by the radioactive material contained in the container, the perimeter wall and the lid of the shielding module comprise, in section, a layer of concrete arranged between an inner layer and an outer layer of steel.

It should be noted that the lid may be fixed to the perimeter wall of the shielding module by means of screws or other similar elements, or it can be fitted on the upper end of the perimeter wall, or simply supported on said perimeter wall.

### BRIEF DESCRIPTION OF THE CONTENTS OF THE DRAWINGS

In order to complement the description that is being carried out and with the purpose of facilitating the understanding of the characteristics of the invention, the present description is accompanied by a set of drawings wherein, by way of an illustrative and non-limiting example, the following has been represented:
FIG. 1 shows a perspective view of an exemplary embodiment of the shielding module for radioactive waste containers, provided with a single-piece wall and without a base.
FIG. 2 shows a perspective view of the shielding module of FIG. 1, vertically sectioned by a diametrical plane and in which the metal container containing the canister (not shown) with the radioactive waste has been schematically represented.
FIG. 3 shows a section of the shielding module, analogous to that of FIG. 2, without the container inside.
FIG. 3a shows a schematic elevational view of the shielding module, sectioned by a vertical plane and in which the metal elements forming means for limiting lateral movement, for centring and for dampening the container with respect to said shielding module have been schematically represented.
FIG. 4 shows a plan view of the shielding module receptacle of FIG. 3a, sectioned by a horizontal plane with the waste container inside, and in which the distribution of the metal elements on the inner contour of said shielding module can be seen.

FIGS. 5 and 6 show respective perspective views of a first embodiment variant of the shielding module, with the inner container and without the inner container, respectively, and provided with a base for supporting the container.
FIG. 7 shows a second embodiment variant of the shielding module, in which the perimeter wall is made up of two wall sections overlapped and fitted to each other by tongue and groove joining.
FIG. 8 shows a perspective view of the shielding module of FIG. 7, vertically sectioned by a diametrical plane.
FIG. 9 shows an elevational partial view of an exemplary embodiment of the shielding module sectioned by a vertical plane, in which the steel structure of the perimeter wall has been represented, without the concrete filling, made up of two wall sections fitted by a tongue and groove joining, and the upper lid, fixed by screws.
FIG. 10 shows an exploded perspective view of the portion of the module of FIG. 9.
FIG. 11 shows a top plan view of the steel structure of the lower section of the perimeter wall shown in FIGS. 9 and 10.

### DETAILED EXPLANATION OF EMBODIMENTS OF THE INVENTION

In the exemplary embodiment shown in FIGS. 1 to 4, the shielding module (10) comprises a single-piece perimeter wall (1) and a closing lid (2), which define a cavity (3) suitable for housing a waste container (C) to be shielded, schematically depicted in FIG. 2.

The shielding module (10) laterally comprises upper and lower windows (61, 62), which favour an upward circulation of air, by convection, and the exit through the upper windows (61) of the heat released by the container (20) in the space between said container (C) and the shielding module (10).

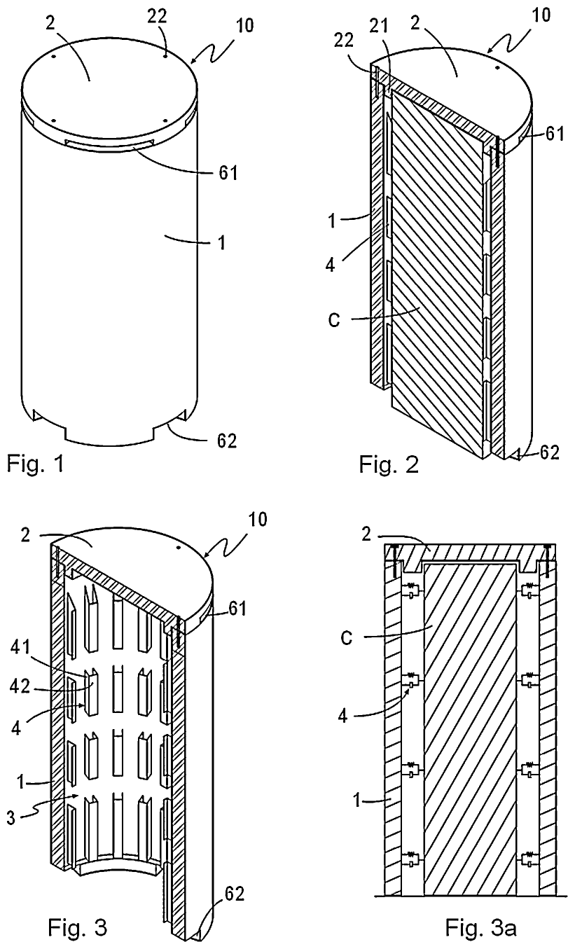

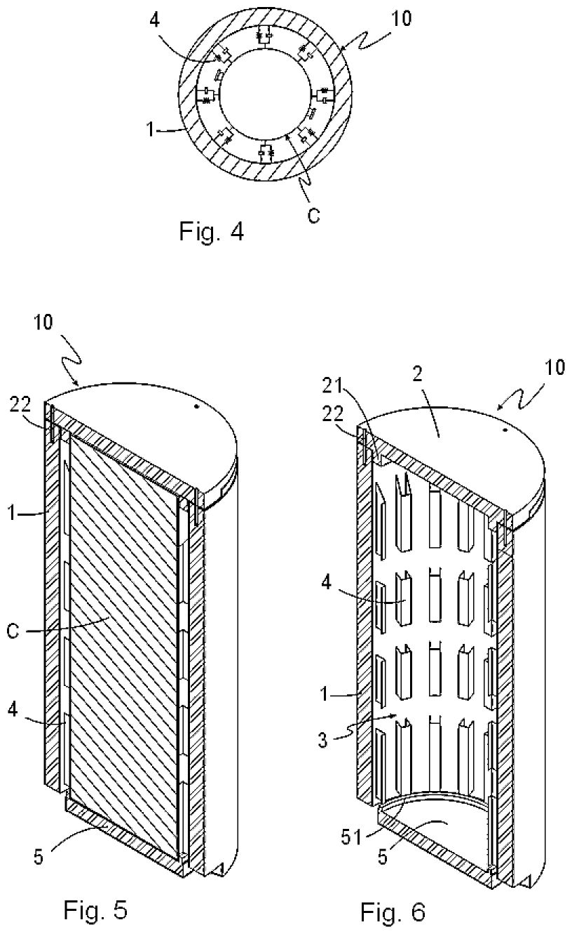

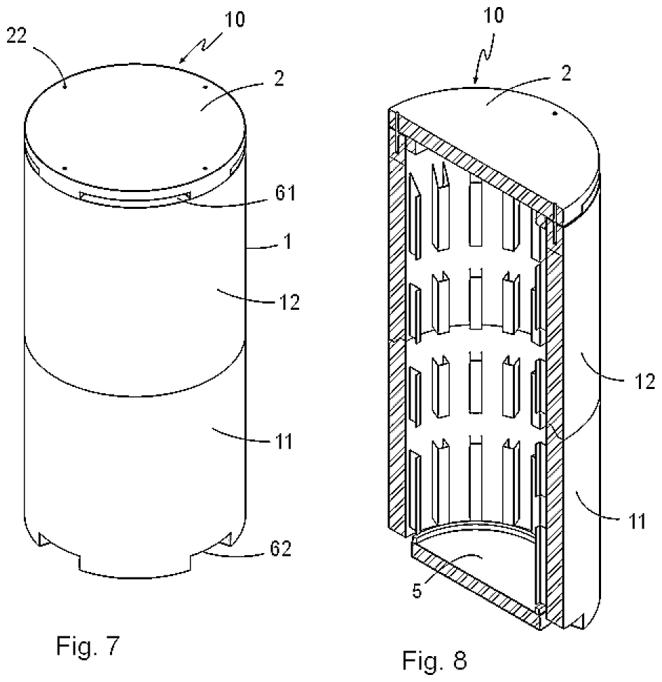

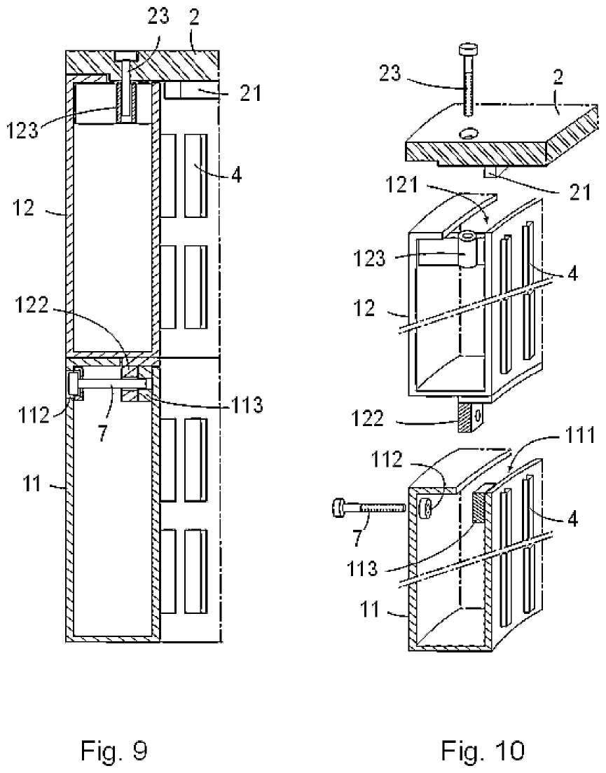

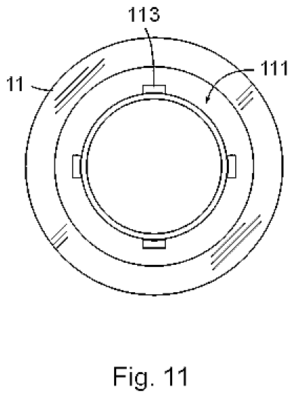

As shown in FIGS. 3 and 4, the shielding module (10) comprises a number of metal elements (4) attached to the perimeter wall (1) and protruding into said cavity (C) of the shielding module (10).

Said metal elements (4) form means for limiting lateral movement, for centring and for dampening the container (C) with respect to said shielding module (10), thus protecting it in the event that the shielding module (10) receives an external impact or the shielding module and the container fall sideways due to an earthquake or any other cause.

In the embodiment of FIG. 3, the metal elements (4) are constituted by metal sheets and oriented in an upward direction, specifically vertically, defining upward air circulation passages, by convection, between the lower windows (62) and the upper windows (61) of the shielding module (10).

In said embodiment, the metal elements (4) have a general “U”-shaped section, provided with wings (41) attached to the perimeter wall (1), and a web (42) oriented towards the inside of the shielding module (10).

The metal elements (4) that form the means for limiting lateral movement, for centring and for dampening the container with respect to said shielding module, have been schematically represented in FIGS. 3a and 4, by means of a symbol that represents said functions. Said metal elements (4) may have a configuration different from the “U”-shaped section mentioned above.

As shown in FIG. 4, the metal elements (4) are circularly distributed on the perimeter wall (1) of the shielding module (10) and face radially the outer surface of the container (C), so that said metal elements (4) form an eventual contact surface with the container (C) housed inside said shielding module (10).

The lid (2) comprises on its inner face a perimeter projection (21) for centring the container (C) and, in this exemplary embodiment, is fixed on the perimeter wall (1) by means of screws (22).

In the first embodiment variant, shown in FIGS. 4 and 5, the shielding module (10) has the characteristics described in the previous embodiment and has the particularity of additionally comprising a base (5) for supporting the container (C); said base (5) being arranged concentrically with respect to the perimeter wall (1) of the shielding module (10).

Said base (5) comprises on its inner face a projection (51), for centring the container, (20) which delimits the support area of said container (C) on the base (5).

It is envisaged that the lid (2) and/or the base (5) may include damping elements (not shown) similar to those located on the perimeter wall of the shielding module.

In the second embodiment variant, shown in FIGS. 7 and 8, the perimeter wall (1) of the shielding module (10) is constituted by several wall sections (11, 12) fitted together, in this case by tongue and groove joining.

In the different embodiments shown, the perimeter wall (1) and the lid (2) and, where appropriate, the base (5), comprise a layer of concrete arranged between an inner layer and an outer layer of steel.

In the exemplary embodiment shown in FIGS. 9 and 10, the lower section (11) and the upper section (12) of the perimeter wall (1) comprise respective hollow steel metal structures, provided with an upper mouth (111, 121) suitable for filling with concrete and the tongue and groove fitting of the upper section (12) and the lid (2), respectively.

The upper section (12) comprises, at its lower end, anchoring blocks (122) housed vertically in the lower section (11) and provided with respective horizontal holes for the passage of fixing screws (7) from the upper section (12) to the lower section (11).

The lower section (11) externally comprises housings (112) for the heads of the fixing screws (7) that access the interior of said lower section (11) and pass through the holes of the anchoring blocks (122) of the upper section (12), said lower section (11) comprising, internally, plates (113) provided with respective threaded mounting holes of the fixing screws (7).

The plates (113) are radially facing the respective housings (112) and are distributed around the lower section (11), as shown in FIG. 11, leaving practically the entire upper mouth (111) of the lower section (11) free for the pouring of concrete therein.

The upper section (12) of the perimeter wall (1) of the shielding module has internally, vertically facing its upper mouth (121), a series of nuts (123) for mounting fixing screws (23) from the lid (2) to said upper section (12).

In this embodiment, the lid (2) comprises housings for the heads of the fixing screws (23), so that they are recessed with respect to the outer surface of the shielding module, as are the heads of the fixing screws (7).

Once the nature of the invention as well as an example of preferred embodiment have been sufficiently described, it is stated for all pertinent purposes that the materials, shape, size and arrangement of the elements described are susceptible to changes, provided that these do not involve an alteration of the essential features of the invention which are claimed below.

1. A shielding module for a radioactive waste container (C), comprising a perimeter wall (1) with at least an upper section (12) and a lower section (11), overlapped and coupled to each other, and a closing lid (2), which define a cavity (3) suitable for housing the container (C), and a number of metal elements (4) attached along the perimeter wall (1) and protruding into said cavity (3), said metal elements (4) forming means for limiting lateral movement, for centring and for dampening impacts against the side wall of the container (C) with respect to the shielding module (10), in the event of potential external impacts or the sideways fall of the assembly formed by the container (C) and the shielding module (10), characterised in thatthe lower section (11) and the upper section (12) of the perimeter wall (1) comprise respective hollow steel metal structures, provided with an upper mouth (111, 121) for filling with concrete and the tongue and groove fitting of the upper section (12) and the lid (2), respectively, and that the upper section (12) comprises, at its lower end, anchoring blocks (122) housed vertically in the lower section (11) and provided with respective horizontal holes for the passage of fixing screws (7) from the upper section (12) to the lower section (1).

2. The shielding module, according to claim 1, characterised in that it laterally comprises upper and lower windows (61, 62) for transferring the heat released by the container (20) inside the shielding module (10), by convection, between the interior and exterior of the module.

3. The shielding module, according to claim 2, characterised in that the metal elements (4) are oriented in an upward direction, define heat circulation passages, by convection, between the lower windows (62) and the upper windows (61) of the shielding module (10), and are arranged along the inner wall of the shielding module (10), defining an eventual contact surface with the wall of the container in case of external impact or fall.

4. The shielding module, according to claim 1, characterised in that the metal elements (4) have a general “U”-shaped section, provided with wings (41) attached to the perimeter wall, and a web (42) facing the inside of the shielding module (10) that forms an eventual contact surface with the container (C) housed inside said shielding module (10).

5. The shielding module, according to claim 1, characterised in that the perimeter wall (1) and the lid (2) comprise a concrete layer arranged between an inner layer and an outer layer of steel.

6. The shielding module, according to claim 1, characterised in that the lid (2) comprises on its inner face a perimeter projection (21) for centring the container (C).

7. The shielding module, according to claim 1, characterised in that it comprises a base (5) for supporting the container (C), arranged concentrically with respect to the perimeter wall (1) of the shielding module (10).

8. The shielding module, according to claim 7, characterised in that the base (5) comprises on its inner face a projection (51) for centring the container (20) that delimits an area for supporting said container (C).

9. The shielding module, according to claim 1, characterised in that the lower section (11) externally comprises housings (112) for the heads of the fixing screws (7) that access the interior of said lower section and pass through the holes of the anchoring blocks (122) of the upper section, said lower section (11) comprising, internally, plates (113) provided with respective threaded mounting holes of the fixing screws (7).

10. The shielding module, according to claim 9, characterised in that the plates (113) are radially facing the respective housings (112) and are distributed around the lower section (11), leaving most of the upper mouth (111) free.

11. The shielding module, according to claim 1, characterised in that the upper section (12) of the perimeter wall (1) of the shielding module has internally, vertically facing its upper mouth (121), a series of nuts (123) for mounting fixing screws (23) from the lid (2) to said upper section (12).

12. The shielding module, according to claim 1, characterised in that the lid (2) comprises housings for the heads of the fixing screws (23) in a recessed position with respect to the outer surface of the shielding module (10).
